(19) United States
(12) Patent Application Publication
(10) Pub. No.: US 2008/0046468 A1
(43) Pub. Date: Feb. 21, 2008

(54) FONT PROCESSING SYSTEM AND METHOD

(75) Inventors: Vikram Salwan, New Delhi (IN); Arun Gupta, Faridabad (IN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PIXTEL MEDIA TECHNOLOGY (P) LTD., Noida (U.P.) (IN)

(21) Appl. No.: 11/770,775

(22) Filed: Jun. 29, 2007

(30) Foreign Application Priority Data
Aug. 18, 2006 (IN) 1850/DEL/2006

(51) Int. Cl. G06F 17/00

(52) U.S. Cl. 707/104.1

(57) ABSTRACT

An embodiment of a font processing system is provided, comprising a font database, a first array, a second array, and a processor. The font database stores multiple font files, each of which corresponds to a character identified by a character code, with each of the font files stored at a font file address. The first array stores multiple first items, with each of the first items storing information regarding addresses of a set of the font files corresponding to consecutive character codes. The second array stores multiple second items, with each of the second item storing information indicating a set of first items related to a specific value of predefined bits. The processor receives an input character code, acquires one of the second items according to a value of the predefined bits of the input character code, acquires a set of first items indicated by the acquired second item, acquires an address of the input character code by inspecting the acquired set of first items, and acquires a font file corresponding to the input character code from the acquired address.

### CROSS REFERENCE TO RELATED APPLICATIONS

This application claims priority of India Provisional Patent Application Serial No. 1850/DEL/2006, filed Aug. 8, 2006. The contents of the provisional applications are hereby incorporated by reference.

### BACKGROUND

The invention relates to font data processing and in particular to a method and system of storing and accessing font data.

An increase in the usage of multilingual applications has required that manufacturers provide multiple languages on mobile devices, experiencing resource limitations. Access of a font on a device depends on the manner in which the corresponding font data is stored. Mapping information is required to identify the font data in a font database.

The memory and access time requirements are excessive for a mobile device. Therefore, a method providing a fast and efficient access to font data is required.

### SUMMARY

An embodiment of a font processing system is provided, comprising a font database, a first array (e.g. a LSB range array), a second array (e.g. a font array), and a processor. The font database stores multiple font files, each of which corresponds to a character identified by a character code, with each of the font files stored at a font file address. The first array stores multiple first items, with each of the first items storing information regarding addresses of a set of the font files corresponding to consecutive character codes. The second array stores multiple second items, with each of the second item storing information indicating a set of first items related to a specific value of predefined bits. The processor receives an input character code, acquires one of the second items according to a value of the predefined bits of the input character code, acquires a set of first items indicated by the acquired second item, acquires an address of the input character code by inspecting the acquired set of first items, and acquires a font file corresponding to the input character code from the acquired address.

An embodiment of a font processing method, employed in an electronic apparatus, is provided. A font database storing multiple font files is provided, each of which corresponding to a character identified by a character code, with each of the font files stored at a font file address. A first array (e.g. a LSB range array) storing multiple first items is provided, with each of the first items storing information regarding addresses of a set of the font files corresponding to consecutive character codes. A second array (e.g. a font array) storing multiple second items is provided, with each of the second items storing information indicating a set of first items related to a specific value of predefined bits. An input character code is acquired. One of the second items is acquired according to a value of the predefined bits of the input character code. A set of first items indicated by the acquired second item is acquired. An address of the input character code is acquired by inspecting the acquired set of first items. A font file corresponding to the input character code is acquired from the acquired address.

### DESCRIPTION OF THE DRAWINGS

The invention can be more fully understood by reading the subsequent detailed description and examples with references made to the accompanying drawings, wherein:

FIG. 1 is a schematic view of an embodiment of a font processing system;

FIG. 2 is a flowchart of an embodiment of a font processing method; and

FIG. 3 is a schematic diagram of exemplary font files, font items and LSB range items.

### DETAILED DESCRIPTION

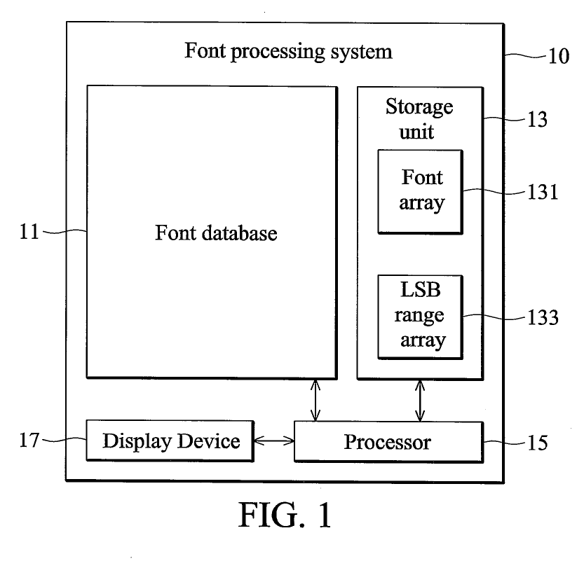

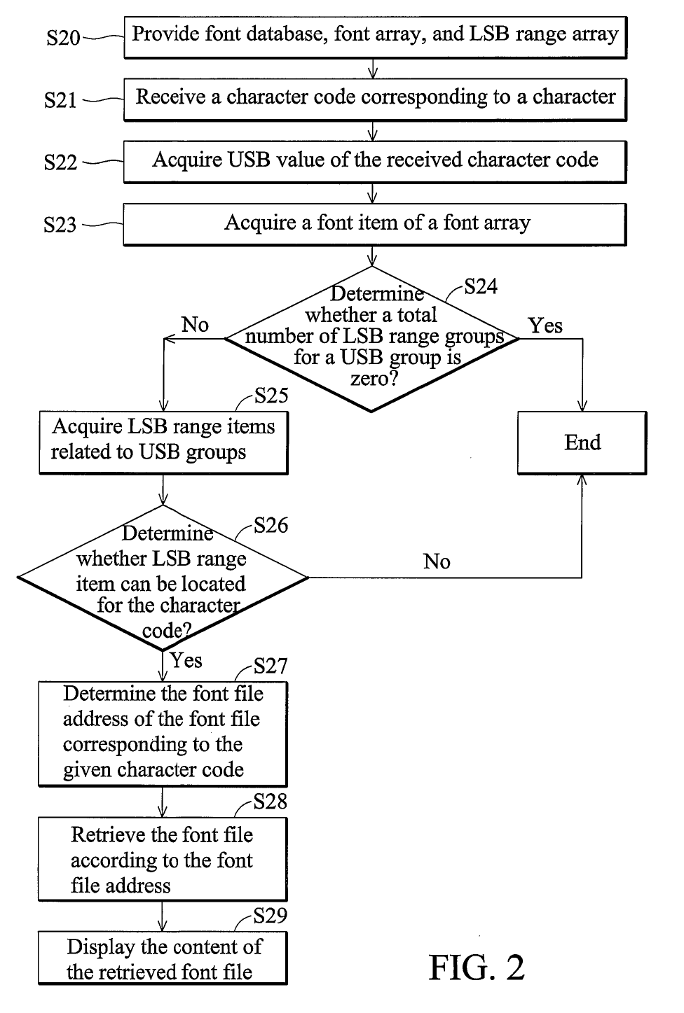

The invention will now be described with reference to FIGS. 1 and 2, which generally relate to processing of font data.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures.

The method is particularly useful for written languages having discontinuous character codes of font data.

According to the embodiment of the font processing method, a Universal Character Set (UCS) is utilized, whereby each character of a written language is assigned a unique number (character code). Here, a UCS-2 coding system is used as an example, wherein each character code comprises 2 bytes, i.e., an upper significant byte and a lower significant byte.

FIG. 1 is a schematic view of an embodiment of a font processing system. A font processing system 10 comprises a font database 11, a storage unit 13, a processor 15, and a display device.

The font database 11 stores a plurality of font files, each of which corresponds to a character identified by a character code. Each of the font files is stored at a font file address. These font files of a fixed size, such as 24, 32, 36 bytes, and the like, are stored in consecutive storage space of the font database 11. Note that one font file only means font data of one character. In actual, the font data of characters is stored in consecutive storage space of static memory, but stored in separate physical files governed by a file system.

For example, the character code is set according to a Universal character set (UCS) coding system, wherein each character of a written language is assigned a unique integer number (a character code, or a code value). Here, the character code comprises 2 bytes, i.e., an upper significant byte (USB) and a lower significant byte (LSB).

Character codes are grouped into USB groups according to USB values thereof. For example, a USB group identified by index 0 contains character codes within a range from “0x0000” to “0x00FF” with USB values “0x00”. A USB group identified by index 1 contains character codes within a range from “0x0100” to “0x01FF” with USB values “0x01”. A USB group identified by index 255 contains character codes within a range from “0xFF00” to “0xFFFF” with USB values “0xFF”. Furthermore, character codes within a USB group are grouped into LSB range groups according to continuity of LSB values thereof. For example, LSB values of character codes {164, 167, 168, 175, 176, 177}, i.e. {0x00A4, 0x00A7, 0x00A8, 0x00AF, 0x00B0, 0x00B1}, are grouped into three LSB range groups {164}, {167, 168}, {175, 176, 177} according to continuity of LSB values thereof. The storage unit 13 stores a font array 131 and a LSB range array 133. The font array 131 stores at most 256 font items, and each font item stores profile data related to LSB range groups of a corresponding USB group. An exemplary data structure of the font array 131 is presented in the following:
Struct USBFontArray {U16 nInitial; U16 nEntries;}
   where the variable “nInitial” represents the minimum index of the LSB range groups of a USB group, and the variable “nEntries” represents a total number of LSB range groups of the USB group. The LSB range array 133 stores multiple LSB range items, and each LSB range item stores profile data of a LSB range group. An exemplary data structure of the LSB range array 133 is presented in the following:
Struct LSBRangeArray {U8 nInitialRangeVal; U8 nFinalRangeVal; U32 nInitialFontOffset;}
   where the variable “nInitialRangeVal” represents the minimum LSB value of a LSB range group, the variable “nFinalRangeVal” represents the maximum LSB value of the LSB range group, and the variable “nInitialFontOffset” represents a relative offset from the beginning of the font database 11 for storing a font file corresponding to the minimum character code.

When a character code is given, a corresponding font file is retrieved from font database 11 by the processor 15. The processor 15 locates a corresponding font file with a given character code according to the font array 131 and the LSB range array 133. The located font file is then retrieved.

The font processing system of FIG. 1 can be implemented in a handheld apparatus, such as a mobile phone.

FIG. 2 is a flowchart of an embodiment of a font character processing method, performed by the processor 15. The method of FIG. 2 can be implemented in the font processing system of FIG. 1. First, the font database 11, font array 131, and LSB range array 133 are provided (step S20). A character code corresponding to a character is received (step S21).

Steps S22˜28 are executed to retrieve a font file corresponding to the given character code presenting the given character. In step S22, the USB value of the received character code is acquired. In step S23, a font item of the font array 131 is acquired, storing profile data of a USB group corresponding to the acquired USB value. In step S24, it is determined whether a total number of LSB range groups for the USB group is zero by inspecting the acquired font item, e.g. USBFontArray[i].nEntries=0, where i represents the USB value, and if so, the given character code correspond to no font files, and the method ends. Otherwise, the method proceeds to step S25. In step S25, multiple LSB range items related to the acquired USB group are acquired, and the acquired LSB range items are searched for the given character code. For example, a start index of LSB range items related to the acquired USB group, denoted as “Iₛ”, is determined as USBFontArray[i].nInitial, and an end index of LSB range items related to the acquired USB group, denoted as “Iₑ”, is determined as USBFontArray[i].nInitial+USBFontArray[i].nEntries-1, where i represents the USB value. The acquired LSB range items include LSBRangeArray[Iₛ] to LSBRangeArray[Iₑ]. The step S25 may employee a well-known binary search algorithm to search the acquired LSB range items. If the LSB value of given character code is between the variable “nInitialRangeVal” and “nFinalRangeVal” of one of the acquired LSB range items, the given character code is located in this LSB range item, otherwise, the given character code is not located in one of the acquired LSB range items. In step S26, it is determined whether a LSB range item can be located for the given character code, and if so, the method proceeds to step S27, otherwise, the method ends. In step S27, an address of the font file corresponding to the given character code is determined according to the located LSB range item. For example, the address of the font file is determined as FONT_DATABASE_OFFSET+LSBRangeArrary[j].nInitialFontOffset+(c&0x00FF-LSBRangeArray[j].nInitialRangeVal)×FONT_SIZE, where the constant “FONT_DATABASE_OFFSET” represents an address of the beginning of the font database 11, j represents an index of the located LSB range item, c represents the given character code, the constant “FONT_SIZE” represents the fixed font size. Here, font files stored in the font database 11 have the same size, such as 24, 32, 36 bytes, and the like.

In step S28, the font file is retrieved according to the font file address determined in step S27. In step S29, the content of the retrieved font file is displayed on the display device 19.

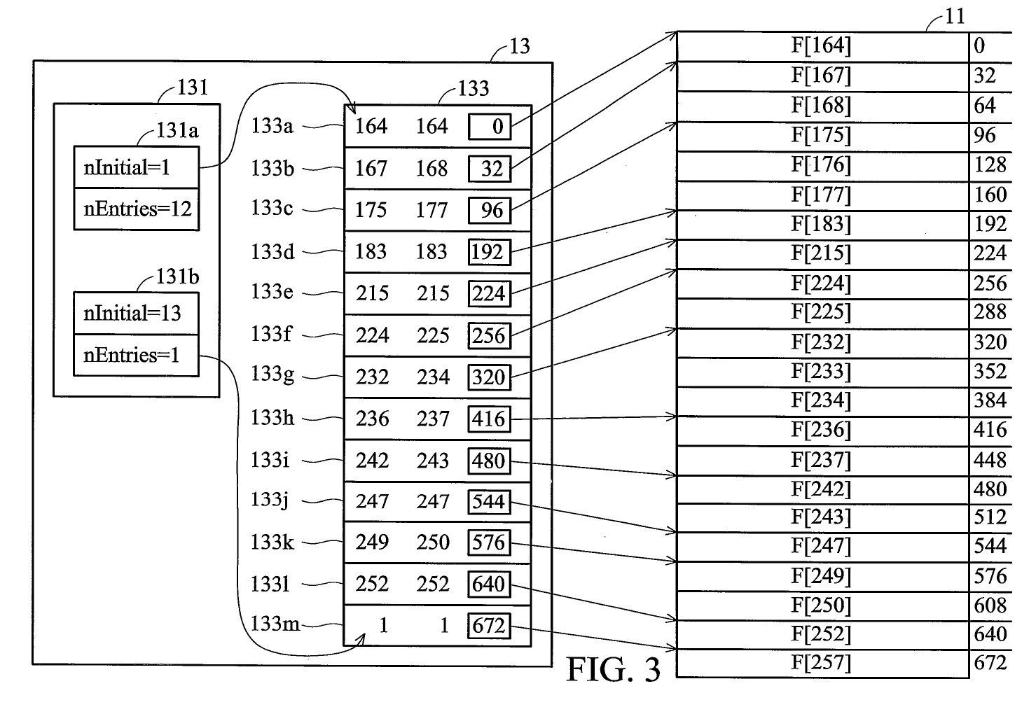

In the following, examples for font processing are described. FIG. 3 is a schematic diagram of exemplary font files, font items and LSB range items.

An embodiment of the font database 11 is described. The font database 11 comprises font files, denoted as F[164] to F[257], corresponding to the following character codes:
{164,167,168,175,176,177,183,215,224,225,232,233,234,236,237,242,243, 247,249,250,252,257}.

The character code is set according to a UCS2 coding system, wherein the character code comprises 2 bytes, i.e., an upper significant byte and a lower significant byte. The character codes are grouped into two USB groups according to USB values thereof.

The first USB group identified by index 0 comprises font files corresponding to character codes less then 255, i.e., having the USB value as 0. The second USB group identified by index 1 comprises font files corresponding to character codes in the range of 256˜511, i.e., having the USB value as 1.

In other words, the first USB group comprises font files corresponding to the following character codes:

{164,167,168,175,176,177,183,215,224,225,232,233,234,236,237,242,243, 247,249,250,252}.

The second USB group comprises font files corresponding to character codes “257”, and the other USB groups in the font database 11 do not comprise any font files.

In addition, character codes of each USB group are further grouped into LSB range groups according to continuity thereof.

Character codes of the first USB group are organized into 12 LSB range groups:

R001{164}, R002{167,168}, R003{175,176,177}, R004{183}, R005{215}, R006{224,225}, R007{232,233,234}, R008{236,237}, R009{242,243}, R010{247}, R011{249,250}, R012{252}.

Only one LSB range group R101 of the second USB group comprises the character code (257).

A font array 131 and a LSB range array 133 corresponding to the font database 11 are established. The font array stores two font items 131a and 131b. The LSB range array 133 stores thirteen LSB range items 133a to 133m.

The font item 131a stores information identifying the beginning index of the LSB range items, and a total number of LSB range items for the first USB group. The font item 131b stores information identifying the beginning index of the LSB range items, and a total number of LSB range items for the second USB group.

Accordingly, the font item 131a stores nInitial=1 and nEntries=12, specifying that the beginning index of the LSB range items for the first USB group is 1, and the total number of the LSB range items for the first USB group is 12. Similarly, the font item 131b stores nInitial=13 and nEntries=1, specifying that the beginning index of the LSB range items for the second USB is 13, and the total number of the LSB range items of the second USB group is 1.

The LSB range array 133 stores information specifying a minimum character code and a maximum character code, and an offset of the font file (font file start address) corresponding to the minimum character code for each LSB range group, e.g. one of R001˜R012 and R101. The specified information for LSB range group R001˜R012 and R101 are stored in LSB range items 133a to 133m.

Here, each of the font files is 32 bytes. Accordingly, the LSB range groups R001˜R012 and R101 can be defined as shown in Table 1.

TABLE 1

| LSB range group | LSB range item |
|---|---|
| R001{164} | {164, 164, 0} |
| R002{167, 168} | {167, 168, 32} |
| R003{175, 176, 177} | {175, 177, 96} |
| R004{183} | {183, 183, 192} |
| R005{251} | {215, 215, 224} |
| R006{224, 225} | {224, 225, 256} |
| R007{232, 233, 234} | {232, 234, 320} |
| R008{236, 237} | {236, 237, 416} |
| R009{242, 243} | {242, 243, 480} |
| R010{247} | {247, 247, 544} |
| R011{249, 250} | {249, 250, 576} |
| R012{252} | {252, 252, 640} |
| R101{257} | {1, 1, 672} |

The minimum and maximum character codes specified in the LSB range item can be recorded using the lower significant byte of the corresponding character code. Accordingly, because the lower significant byte of the character code 257 is 1, the LSB range item corresponding to the LSB range group R101 is recorded as {1,1,672}.

With reference to FIG. 2, an example for accessing a font file corresponding to a given character code is described.

In the following, the alphanumeric value “c” is used as an example.

A character code “23322(0x5b1a)” corresponding to the alphanumeric value “c” is received (step S21). In step S22, the USB value of the given character code is acquired. Here, the USB value is 91 (0x5b). In step S23, a font item of the font array 131 corresponding to the acquired USB value is acquired, denoted as USBFontArray[91]. In step S24, it is determined whether a total number of LSB range groups for the acquired USB group is zero, and if so, the given character code correspond to no font files, and the method ends, otherwise, the method proceeds to step S25. In step S25, multiple LSB range items related to the acquired USB group are acquired, and the acquired LSB range items are searched for the given character code.

If the font item USBFontArray[91] is specified as {Rᵢ, N}, wherein Rᵢ is a start index of LSB range items related to the acquired USB group, and N is a total number of LSB range items for the USB group, an end index of LSB range item (R_{f}) for the USB group can be determined accordingly. Here, the f=(i+N−1). Each LSB range item between the Rᵢ and R_{f} specifies minimum and maximum LSB values. A binary search is then performed to locate a relevant LSB range item. For example, if the LSB value of given character code (23322) exceeds the minimum LSB of a LSB range Rₘ, and the LSB value of given character code (23322) is lower than the maximum LSB of the LSB range Rₘ, it can be determined that the given character code (23322) is located in the LSB range Rₘ. In step S26, it is determined whether the LSB range Rₘ comprising the given character code has been found, and if so, the method proceeds to step S27, otherwise, the method ends. In step S27, the font file address of the font file corresponding to the given character code (23322) is determined. Here, each character has the same font size. Accordingly, the offset of the font file can be determined according to the offset of the font file corresponding to the beginning character code of the LSB range Rₘ and the font size.

In step S28, the font file is retrieved according to the offset of the font file determined in step S27. In step S29, the content of retrieved font file is displayed on the display device 19.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A font processing system, comprising:
a font database storing a plurality of font files, each of which corresponds to a character identified by a character code, with each of the font files stored at a font file address;
a first array storing a plurality of first items, with each of the first items storing information regarding addresses of a set of the font files corresponding to a plurality of consecutive character codes;
a second array storing a plurality of second items, with each of the second item storing information indicating a set of first items related to a specific value of a plurality of predefined bits; and
a processor receiving an input character code, acquiring one of the second items according to a value of the predefined bits of the input character code, acquiring a set of first items indicated by the acquired second item, acquiring an address of the input character code by inspecting the acquired set of first items, and acquiring a font file corresponding to the input character code from the acquired address.

2. The font processing system of claim 1, wherein the character code is set according to a Universal character set (UCS) coding system.

3. The font processing system of claim 2, wherein the character code comprises an upper significant byte (USB) and a lower significant byte (LSB).

4. The font processing system of claim 3, wherein the predefined bits comprise the USB.

5. The font processing system of claim 1, wherein each second item stores information indicating the minimum index of a set of first items, and a total number of the set of first items.

6. The font processing system of claim 5, wherein the processor acquires the first items with indices between the minimum index of a set of first items indicated by the acquired second item, and the minimum index of the set of first times plus the total number of the set of first items minus one, indicated by the acquired second item.

7. The font processing system of claim 1, wherein each first item stores information indicating a first lower significant byte (LSB) value of a minimum character code of a plurality of consecutive character codes, a second LSB value of a maximum character code of the consecutive character codes, and a font file start address of a font file corresponding to the first LSB value of the minimum character code of the consecutive character codes.

8. The font processing system of claim 7, wherein the processor acquires one of the first items indicated by the acquired second item, comprising information indicating a range of a first LSB value of a minimum character code, and a second LSB value of a maximum character code of the consecutive character codes covering the LSB value of the input character code, and acquires the address of the input character code with reference to information stored in the acquired first item.

9. The font processing system of claim 8, wherein the address of the input character code is calculated by an equation:
$$Addr = FONT\_DATABASE \_OFFSET + LSBRangeArrary [ j ] . nInitialFontOffset + ( c \& 0 \times 00 FF - LSBRangeArray [ j ] . nInitialRangeVal ) \times FONT\_SIZE ;$$
the constant “FONT_DATABASE_OFFSET” represents an address of the beginning of the font database, j represents an index of the acquired first item, c represents the input character code, LSBRangeArrary[j].nInitialFontOffset represents a relative offset for the first LSB value of the minimum character code, LSBRangeArray[j].nInitialRangeVal represents the first LSB value of the minimum character code, and the constant “FONT_SIZE” represents a font size in bytes.

10. The font processing system of claim 1, wherein the font processing system is implemented in a handheld apparatus.

11. The font processing system of claim 1, further comprising a display device, wherein the processor displays the content of the acquired font file on the display device.

12. A font processing method, employed in an electronic apparatus, comprising:
providing a font database storing a plurality of font files, each of which corresponding to a character identified by a character code, with each of the font files stored at a font file address;
providing a first array storing a plurality of first items, with each of the first items storing information regarding addresses of a set of the font files corresponding to a plurality of consecutive character codes;
providing a second array storing a plurality of second items, with each of the second items storing information indicating a set of first items related to a specific value of a plurality of predefined bits;
receiving an input character code;
acquiring one of the second items according to a value of the predefined bits of the input character code;
acquiring a set of first items indicated by the acquired second item;
acquiring an address of the input character code by inspecting the acquired set of first items; and
acquiring a font file corresponding to the input character code from the acquired address.

13. The font processing method of claim 12, wherein the character code is set according to a Universal character set (UCS) coding system.

14. The font processing method of claim 13, wherein the character code comprises an upper significant byte and a lower significant byte.

15. The font processing method of claim 14, wherein the predefined bits comprise the USB.

16. The font processing method of claim 12, wherein each second item stores information indicating the minimum index of a set of first items, and a total number of the set of first items.

17. The font processing method of claim 16, wherein the first items is acquired, with indices between the minimum index of a set of first items indicated by the acquired second item, and the minimum index of the set of first times plus the total number of the set of first items minus one, indicated by the acquired second item.

18. The font processing method of claim 12, wherein each first item stores information indicating a first lower significant byte (LSB) value of a minimum character code of a plurality of consecutive character codes, a second LSB value of a maximum character code of the consecutive character codes, and a font file start address of a font file corresponding to the first LSB value of the minimum character code of the consecutive character codes.

19. The font processing method of claim 18, wherein one of the first items indicated by the acquired second item is acquired, comprising information indicating a range of a first LSB value of a minimum character code, and a second LSB value of a maximum character code of the consecutive character codes covering the LSB value of the input character code, and the address of the input character code is acquired with reference to information stored in the acquired first item.

20. The font processing method of claim 19, wherein the address of the input character code is calculated by an equation:
$$Addr = FONT\_DATABASE \_OFFSET + LSBRangeArrary [ j ] . nInitialFontOffset + ( c - LSBRangeArray [ j ] . nInitialRangeVal ) \times FONT\_SIZE ;$$
the constant “FONT_DATABASE_OFFSET” represents an address of the beginning of the font database, j represents an index of the acquired first item, c represents the input character code, LSBRangeArrary[j].nInitialFontOffset represents a relative offset for the first LSB value of the minimum character code, LSBRangeArray[j].nInitialRangeVal represents the first LSB value of the minimum character code, and the constant “FONT_SIZE” represents a font size in bytes.

21. The font processing method of claim 12, wherein the electronic apparatus is a handheld apparatus.

22. The font processing method of claim 12, further comprising displaying the content of the acquired font file on a display device.
